(19) United States
(12) Patent Application Publication
(10) Pub. No.: US 2026/0155316 A1
(43) Pub. Date: Jun. 4, 2026

(54) POUCH CELL POLYMERIC SUPERCAPACITOR

(71) Applicants: Manoj Kumar Ram, Palm Harbor, FL (US); Brandon Xavier Lorentz, El Dorado, AR (US); Michael Thomas Sheridan, Cordova, TN (US)

(72) Inventors: Manoj Kumar Ram, Palm Harbor, FL (US); Brandon Xavier Lorentz, El Dorado, AR (US); Michael Thomas Sheridan, Cordova, TN (US)

(21) Appl. No.: 18/960,315

(22) Filed: Nov. 26, 2024

Related U.S. Application Data
(60) Provisional application No. 63/713,137, filed on Oct. 29, 2024.

(51) Int. Cl. H01G 11/28; H01G 11/48; H01G 11/56; H01G 11/68; H01G 11/86

(52) U.S. Cl. CPC H01G 11/28; H01G 11/48; H01G 11/56; H01G 11/68; H01G 11/86

(57) ABSTRACT

The pouch cell polymeric supercapacitor invention described here-in is a first of its kind supercapacitor utilizing a biodegradable and low cost conducting polymeric composite of polyaniline with or without molybdenum disulfide and with or without a pyrolyzed cellulose material such as pyrolyzed bacterial cellulose. The materials, their synthesis, component fabrication, assembly, and packaging materials and techniques are detailed and claimed for the pouch cell designed supercapacitor. State-of-the-art capacitive, energy, and life cycling performance are described and corroborated through rigorous electrochemical testing, outperforming marketed supercapacitors relying on activated carbons and rare earth minerals alone. Furthermore, the synthesis of the conducting polymer and bacterial cellulose composite as well as the electrolyte is incredibly facile and scalable with significantly lower materials and manufacturing costs when compared to that of commercial supercapacitors to date.

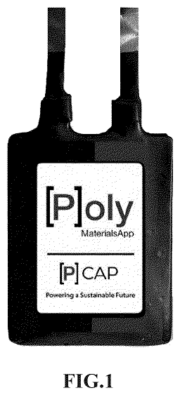

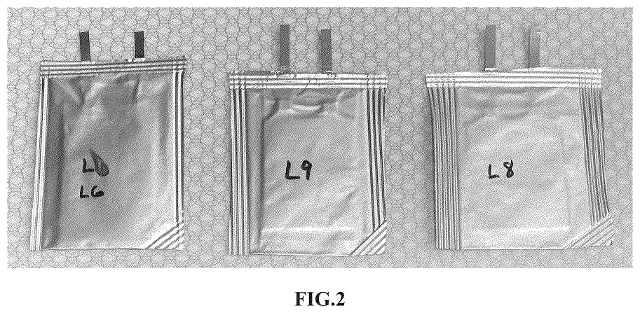

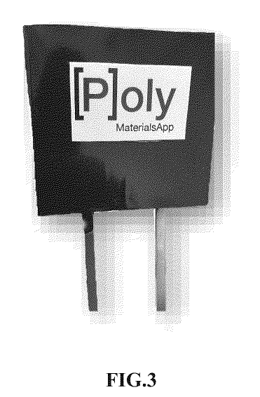

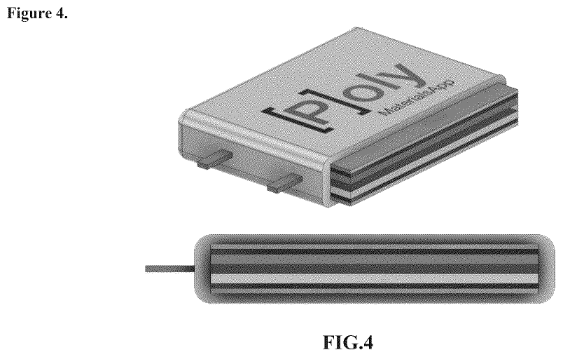

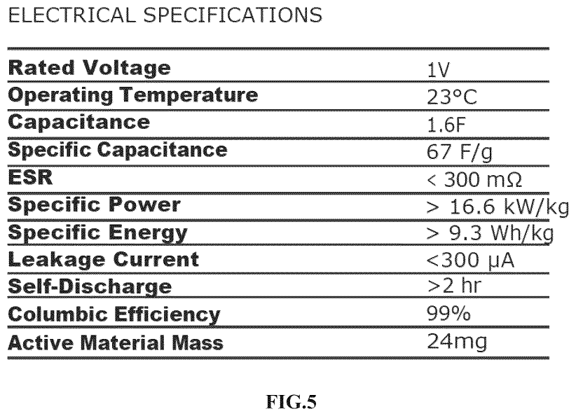

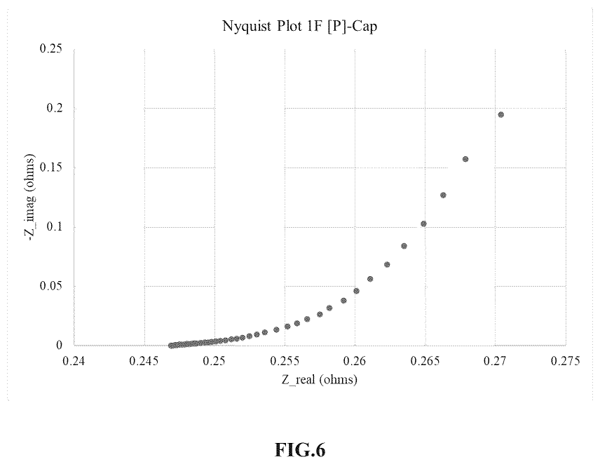

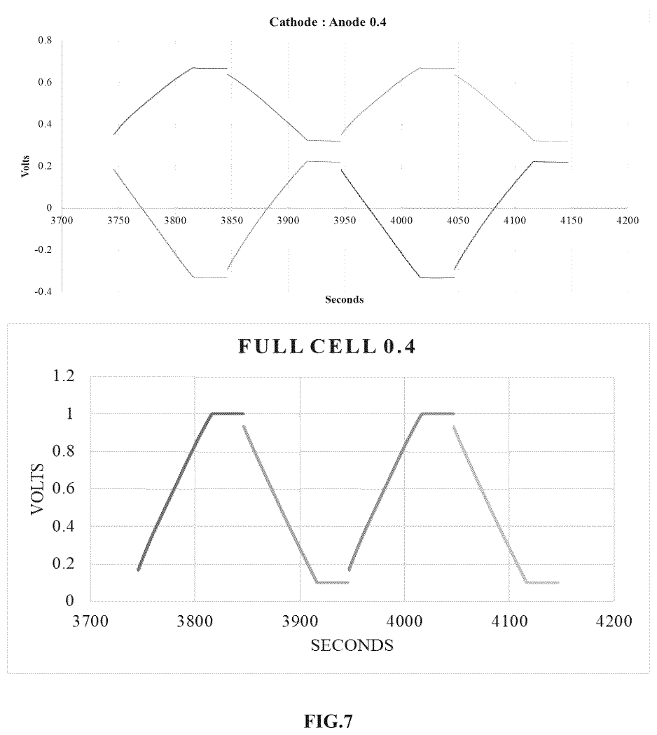

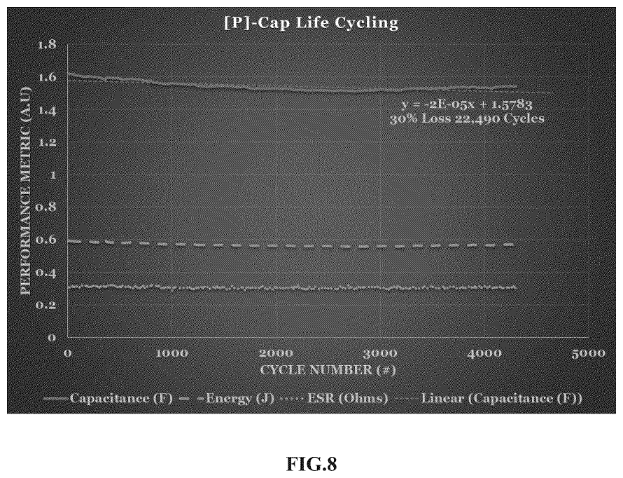

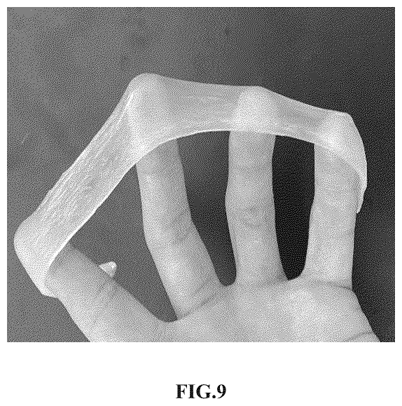

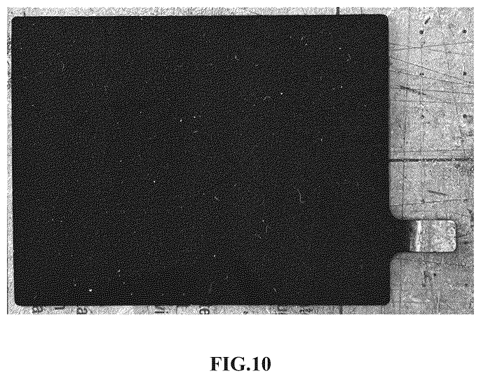

### CROSS-REFERENCE TO RELATED APPLICATION(S)

The present application is based on claims priority to and incorporates herein by references in its entirely for all purposes, U.S. Provisional Patent Application No. 63/713,137, filed on Oct. 29, 2024.

### STATEMENTS REGARDING FEDERALLY SPONSORED RESEARCH

This invention was made with government support under (contract number: HQ0860-21-C-7114) awarded by (Missile Defense Agency). The government has certain rights in the invention.

### REFERENCE TO A SEQUENCE LISTING

Not Applicable

### FIELD OF THE INVENTION

The disclosed technology is the production pouch cell polymeric supercapacitor. The invention describes here-in is a thin film device comprised of a cathode containing a biodegradable composite composed of polyaniline with or without molybdenum disulfide and with or without pyrolyzed bacterial cellulose deposited on a metallic or graphitic current collector, an anode composed of activated carbon deposited on a metallic or graphitic current collector, and a gel, polyvinyl alcohol based acidic electrolyte, containing electrical contacts and packaged in a thin film format with a laminate or a rigid or flexible polymer resin coating of and end article of an asymmetric thin film packaged pouch cell supercapacitor. The biodegradable active materials including a cathodic composite of polyaniline with or without molybdenum disulfide (0-20 wt. %) and with or without pyrolyzed bacterial cellulose (0-50 wt. %) deposited on a rigid or flexible, compressed graphite or metal sheet, an anodic high surface area activated carbon deposited on a rigid or flexible graphite or metal sheet, and a glass transitioned gel electrolyte composed of 0.5-1 molarity hydrochloric acid and 1-20 wt. % polyvinyl alcohol. This invention is unique and is state-of-the-art given that specific capacitances >500 F/g (active material mass) and specific energy of >10 Wh/kg have been achieved, outperforming marketed supercapacitors relying on activated carbons and rare earth minerals alone.

### BACKGROUND OF THE INVENTION

Supercapacitors have received much attention in recent years given the rapid rise of higher power demanding electrical systems breaching the public and private sectors. Supercapacitors are perfect for high power applications, having very low equivalent series resistance (<1 Ohm), high cycle life (>100,000 cycles), and incredibly high charge storage capabilities. Up until today, the state-of-the-art supercapacitors rely on high surface area materials such as activated carbon, synthesized from high-temperature and high-pressure activation steps involving steam reformation, salt activation, and acidic treatment. The high surface area characteristics of activated carbon make them superior materials for electrostatic charge storage in the presence of an ionic solution. Furthermore, many supercapacitor designs incorporate rare metal oxides for enhancing energy density. The resulting performance of supercapacitors utilizing activated carbon and rare earth metal oxides offer up to 200-300 F/g specific capacitance and up to 5-8 Wh/kg specific energy in the best of today's supercapacitor designs.

The invention described here-in presents a pouch cell configuration for a first of its kind supercapacitor utilizing a biodegradable and low cost conducting polymeric composite of polyaniline with or without molybdenum disulfide and with or without a pyrolyzed cellulose material such as pyrolyzed bacterial cellulose. This invention is unique and is state-of-the-art given that specific capacitances >500 F/g (active material mass) and specific energy of >10 Wh/kg have been achieved, outperforming marketed supercapacitors relying on activated carbons and rare earth minerals alone. Furthermore, the synthesis of the conducting polymer and bacterial cellulose is incredibly facile and scalable compared to the intensive conditions required for the formation of activated carbons. Lastly, the materials and manufacturing costs associated with the present invention are significantly lower than that for producing commercial supercapacitors to date.

### SUMMARY OF THE INVENTION

The pouch cell polymeric supercapacitor invention described here-in is a thin film device comprised of a cathode containing a biodegradable composite composed of polyaniline with or without molybdenum disulfide and with or without pyrolyzed bacterial cellulose deposited on a metallic or graphitic current collector, an anode composed of activated carbon deposited on a metallic or graphitic current collector, and a gel, polyvinyl alcohol based acidic electrolyte, containing electrical contacts and packaged in a thin film format with a laminate or a rigid or flexible polymer resin coating (drawings 1, 2, 3, 4).

In the embodiment of the invention where graphite is used as a current collector, a state-of-the-art biodegradable binder such as carboxymethyl cellulose is utilized for adhesion of the active materials. In the embodiment of the invention where a metallic current collector is used, a suitable binder such as polyvinylidene fluoride (PVDF) or polyvinylpyrrolidone (PVP) is utilized.

Fabricated devices using graphite as current collectors is also accompanied by a tab coating procedure using electrodeposition of a metal, predominately copper or aluminum for cost and performance considerations during manufacturing, but may be any metal of interest such as gold, silver, platinum, etc.

The gel, polyvinyl alcohol, acidic electrolyte has undergone a glass state transition and has been precipitated utilizing a freeze-thawing technique.

The fabricated supercapacitor may be packaged using a variety of methods and materials (epoxy, torsion metal/plastic casing, laminated metal/plastic pouches, coin cells, rolled cylindrical canisters) and packaging environments (inert or ambient atmosphere or vacuum). However, the invention described here-in focuses on the thin film pouch cell format with electrodes parallel to one another across the gel membrane.

The invention presented here details the materials, synthesis steps, composite compositions, electrode processing steps, electrolyte processing steps, assembly, packaging materials, and packaging techniques for fabricating the pouch cell polymeric supercapacitor.

### BRIEF DESCRIPTION OF THE DRAWINGS

Drawing 1 displays an embodiment of the pouch cell polymeric supercapacitor, packaged using a flexible rubber via dip coating.

Drawing 2 displays an embodiment of the pouch cell polymeric supercapacitor, packaged using a heat-sealed aluminum laminate material typically used for battery packaging.

Drawing 3 displays an embodiment of the pouch cell polymeric supercapacitor, packaged using a 2-part flexible resin epoxy.

Drawing 4 presents 2 schematic representations of the pouch cell polymeric supercapacitor with an angled and side cross section view with components of the invention identified.

Drawing 5 presents a list for the [P]-Cap electrical specifications for a 1.6F device, characterized following methods outlaid in standard IEC 62391.

Drawing 6 provides a Nyquist Plot from EIS analysis electrical specifications for a 10.3F [P]-Cap device from 100 mHz to 10 MHz.

Drawing 7 presents a balanced [P]-Cap half-cell and full-cell galvanostatic test (12 mA) voltage profiles using a cathode: anode mass ratio=0.4 against a silver/silver chloride reference electrode.

Drawing 8 shows the expected [P]-Cap galvanostatic (12 mA) life cycling capabilities to 0.8V with 30% loss in capacitance forecasted after 22,490 cycles.

Drawing 9 presents an image of the [P]-Cap gel membrane utilizing polyvinyl alcohol.

Drawing 10 shows a copper coated graphite current collector tab after using the electrodeposition technique.

### DETAILED DESCRIPTION OF THE INVENTION

Prior to any embodiments of the invention being disclosed, it is made known here that it is apparent to an artisan of this field of supercapacitors that the invention described here-in is not limited in its application to the details of construction and the arrangement of components set forth in the following description or illustrated in the following drawings. The invention is capable of other embodiments and of being practiced or of being carries out in various ways.

### 1. Definitions

Unless otherwise defined, all technical and scientific terms used herein have the same meaning as commonly understood by one of ordinary skill in the art. In case of conflict, the present document, including definition, will control. Preferred methods and materials are described below, although methods and materials similar or equivalent to those described herein can be used in practice or testing of the present invention. All publications, patent applications, patents, and other references mentioned herein are incorporated by reference in their entirety. The materials, methods, and supercapacitor invention disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, and “consisting of”, the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrase “at least one of A, B, . . . and N” or “at least one of A, B, . . . N, or combinations thereof” are defined in the broadest sense to mean one or more elements selected from the group comprising A, B, . . . and N, that is to say, any combination of one or more elements A, B, . . . or N including any one element alone or in combination with one or more of the other elements, which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to 4” also discloses the range “from 2 to 4”. The term “about” may refer to pus or minus 10% of the indicated number. For example, “about 10%” may indicate a range of 9% to 11%, and “about 1%” may mean from 0.9-1.1%. Other meanings of “about” may be apparent from the context, such as rounding off, so, for example “about 1” may also mean from 0.5 to 1.4.

For the recitation of numeric ranges herein, each intervenin number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

### 2. Polymeric Cathode Composite

The pouch cell polymeric supercapacitor is based on the biodegradable, nontoxic, and high specific capacitance and specific energy performance of polyaniline in its emeraldine salt form when in an uncharged state. Synthesis steps have been detailed in prior patents.

Bacterial cellulose derived from Gluconacetobacter xylinum possess a nano-fibrous structure and is used as a precursor for preparing a pyrolyzed material with high electrical conductivity and structural support for polyaniline through carbon-carbon pi-orbital overlap and hydrogen bonding mechanisms. It is evident to the artisan in the field of conducting polymers and supercapacitors that the cathode does not require the use of the pyrolyzed cellulose. The invention claimed here-in holds claims to a cathodic material of polyaniline with or without molybdenum disulfide (0-20 wt. %) and with or without pyrolyzed bacterial cellulose (0-50 wt. %). The structural support provided by the pyrolyzed bacterial cellulose enables a robust conducting polymeric supercapacitor cathode with higher cycle life than one utilizing polyaniline alone.

The pyrolyzed cellulose, if used, is synthesized by first allowing the cleaned, raw product to dry at up to 120° C. to remove both free and adsorbed water. Following drying, the material is placed in a controlled inert atmosphere of nitrogen or argon for providing antioxidant conditions during heating. A slow heating ramp, typically 2° C./min, is used to ensure completion of thermal transformation steps throughout the pyrolysis procedure. Hold temperatures of 240° C. and 400°, for a residence time proportional to the quantity of cellulose being treated, is used for step-wise thermal transformation of the raw cellulose to an electrically conducting and high surface area nanofibrous carbon material. These temperatures have been identified through thermal gravimetric analysis, where at 240° C. dehydroxylation of branched and ring hydroxyl ions in cellulose takes place, and at 400° C. the slow and steady degradation of the glycosidic links and ether bonds results. Post complete thermal transformation at 400° C., the controlled atmosphere is cooled and inert conditions are supplied until nonoxidizing conditions are met <200° C.

The pyrolyzed cellulose, or cellulose char, may then be used as a scaffold during the polyaniline synthesis reaction described in prior patents. The mass percentage of char in the polymeric composite is between 0-50%. The composite material may be collected and dried for use as the cathodic composite for procuring an embodiment of the pouch cell polymeric supercapacitor.

### Activated Carbon Anodic Composite

The anodic material used for the polymeric supercapacitor may be any activated carbon with the higher surface area materials yielding the greater specific capacitance and specific energy performance.

### Electrode Fabrication

For a device whose current collectors are made of graphite, carboxymethyl cellulose acts as an excellent binder for adhesion of the active materials with the final electrode having good electrical conductivity. The mass percentage of binder in the cathodic and anodic composite is between 5-20%.

The present invention focuses on 2 methods for depositing the active materials onto current collectors for producing electrodes. The first is the use of an ultrasonicating sprayer, where the active material and binder are dispersed in an appropriate solvent and sprayed onto the current collector which resides on a hot plate for efficient solvent evaporation. The ultrasonicating sprayer is ideal for homogenous and high-quality electrodes. Ultrasonic spraying at a given frequency results in the formation of a controlled droplet size provided the solids are of a particle size less than half the diameter of the droplets being formed. The other method of electrode fabrication is a pour a spread thin film technique when an apparatus is used to drag a pool of active material and binder dispersed in a carrier solvent across the current collector. The apparatus used for spreading the material is set at a specific height above the electrode to ensure a 10 micrometer to 1 mm thin film results. The entire electrode is to heated during spreading of the material to evaporate the solvent and form a solid thin film across the current collector for production of the electrode. Note that the viscosity of the active material solution utilizing the pour and spread technique is much greater than that used for ultrasonicating spraying. This is done to ensure the method of deposition is performed correctly and a high-quality electrode is produced.

The coated electrodes are run through a roller press with or without heating to increase the active material film density and subsequent electrical conductivity. A heating temperature of 80° C. is sufficient for performing this operation. This step ensures a thin electrode is produced as well as one with high conductivity and subsequently low resistance. Typically, the active material film thickness is reduced anywhere from 10-50% its initial thickness directly after the deposition step by repeated rolling of the electrodes.

The mass ratio of active material deposited on the cathode to that of the anode is chosen such that the final supercapacitor device is considered balanced. Mass balancing of the cathode and anode is performed utilizing a 3-probe cyclic voltammetry electrochemical analysis of the cathode and of the anode independently against a common counter and reference electrode (drawing 7). The anode and cathode maximum stable voltage limits, in the desired aqueous electrolyte, are measured. Furthermore, their specific capacitances in this voltage window are determined. Based on the theory of equivalent charge separation, the mass of material on the cathode should equate to a charge storage capability near that of the anode, given the operating half-cell voltages of each electrode. In the final assembled device, the experimentally determined cathode to anode mass ratio for a balanced device is not exact given unaccounted for behaviors which arise when using the packaged supercapacitor such as the lead connections, the influence of the 2-probe cathode to anode design rather than a counter and reference electrode in a beaker of electrolyte, any influence due to the assembly process, and the packaging. These unaccounted-for aspects result in slightly different half-cell voltages and higher equivalent series resistance than expected from the 3-probe analysis. Thus, some fine tuning from the optimal starting mass ratio from the 3-probe electrochemical analysis is needed to have a wholly balanced device with minimal equivalent series resistance and optimal performance.

The pouch cell supercapacitor has electrodes as small or large sheets which will be assembled parallel to one another across the gel electrolyte. Electrodes may be used as is after active material deposition or punched out using a die cutter.

The final electrodes should be equipped with a bare tab, not coated with active material, as terminal locations for adhering electrical leads. The tabs should be isolated from the electrolyte, as it is acidic, and will corrode various metals such as copper and aluminum, especially during charging and discharging the packaged supercapacitor. In the instance where graphite is used as a current collector, the tabs may be affixed with an electrical lead (wire, tab, foil, etc.) using a metal or plastic crimp for applying pressure between the graphite tab and the electrical lead, or the bare graphite tab of the electrode is electrodeposited with a thin film of copper or aluminum at a low and constant voltage, typically 0.75V for a short time (10-15 minutes) against a copper cathode (drawing 10). Alternatively, constant current methods for electrodeposition may be employed. The electrodeposition step allows for a solder or welding point for affixing electrical leads such as wire, tabs, foil, etc. The soldering or welding of electrode leads may be performed at this step. Alternatively, if a metal current collector and active material substrate is used, a weld may be formed between the bare electrode tab and the electrical lead for securing a terminal location with low resistance for circuit application and/or device testing.

A voltage burn in step may be utilized for prepping the electrodes prior to electrolyte insertion and supercapacitor assembly. A low voltage burn in step is performed primarily to relax the cathodic composite before assembly and routine operation, since it experiences strong swelling during charging and discharging. The voltage burn in step for the cathode is done in a fashion that allows the polyaniline to undergo redox without going to the completely insulating pernigraniline state. The most stressful state of polyaniline is in its pernigraniline form once charged. In an aqueous 0.5-1M hydrochloric acid polyvinyl alcohol electrolyte, the pernigraniline state forms between 0.7-0.85V versus a silver-silver chloride reference electrode. Thus, a voltage burn in step is performed by charging the cathode in a beaker of electrolyte between 0.5-0.7V versus a silver-silver chloride reference electrode using a high current density (0.5-10 A/g of cathodic active material) for anywhere between 500-15000 charging and discharging cycles. The counter electrode may be a significantly larger surface area carbon coated electrode or the anode to be used in the assembled supercapacitor device, so long as the voltage criteria explained prior is achieved during the burn in. Experimental analysis reveals that this voltage burn in treatment will result in a pure polyaniline cathode that is capable of >5,000 cycles in a balanced and assembled supercapacitor. Furthermore, if pyrolyzed cellulose is used to support polyaniline in the cathode composite, >10,000 charging and discharging cycles may be observed in the balanced and assembled supercapacitor described in this specification, provided the device is charged and discharged with appropriate current draws relative to the capabilities of the materials in the supercapacitor, i.e. for the cathodes described here-in, 10-30 mA/F.

### Electrolyte Synthesis and Preparation

The gel electrolyte is comprised of 5-20 wt. % polyvinyl alcohol (PVA) with the remainder being an aqueous solution of 0.5-1M hydrochloric acid (drawing 9).

The PVA is added to the acidic solution and dissolved at or near 80-100° C. for a residence time proportional to the quantity of gel being made and the time required for complete solids dissolution and full glass transition of PVA. Constant stirring is performed. The resulting viscous liquid, once homogenous is degassed using a vacuum and/or a planetary mixer, and ready for electrode application.

### Supercapacitor Component Assembly

The viscous electrolyte is poured onto the cathode or anode that has been wetted with water. Care is taken not to coat the electrode tabs with electrolyte. The cathode or anode to be coated may or may not be in a mold for maintaining a thickness of applied electrolyte. If a mold is not used, the placement of the electrolyte is such that any “running” to the sides is maintained to the edge of the electrode being coated as best as possible to minimize waste. A thin layer of >100 micron is all that is required for device to operate effectively. Once the cathode or anode has been coated, the other electrode, wetted with water, is placed on top of the gel softly so as to not form air bubbles and form a flat structure with a leveled design. A mold aids in the level placement of the top electrode.

Once the electrodes have been stacked across the gel, the whole assembly is frozen at a temperature ≤5° C. The residence time of freezing depends on the size of the device being fabricated. For a ˜1-10F supercapacitor, 3-5 minutes is sufficient. The assembly is then removed from the freezer and allowed to thaw to near room temperature. After thawing, the device may or may not be taped with a Teflon tape or polymeric adhesive tape at its edges or completely wrapped in tape for holding the electrodes across the electrolyte. The supercapacitor assembly is now prepared for packaging.

### Pouch Cell Polymeric Supercapacitor Packaging

The pouch cell polymeric supercapacitor packaging is quite versatile having many potential materials for encasement: polymethyl methacrylate, silicone, epoxy, polyurethane, polystyrene, rubber, or a formable plastic laminated aluminum packaging as some examples. If a resin is used, it is allowed to cure and dry prior to the pouch cell supercapacitor being ready for operational use. If a laminate style packaging such as the aluminum laminate commonly used for battery pouch cell packaging, a vacuum may be used for evacuating the inside of the pouch with a needle or nozzle prior to heat sealing the internal components from the external environment.

### Pouch Cell Polymeric Supercapacitor Performance

Expected performance metrics for the pouch cell polymeric supercapacitor have been outlain in drawing 5 and 6 following protocols published in standard IEC 62931. Please note a current density of 12 mA/F is recommended for ensuring a supercapacitor cycle life (drawing 8) >20,000 charge-discharge cycles.

We claim:

1. The invention is an asymmetric thin film packaged pouch cell supercapacitor comprised of cathode electrode with active materials with binder on current collector, anode with active material with binder on current collector, electrolyte, electrical leads (terminals) and packaged material.

2. The cathode electrode active material in claim 1 comprised of polyaniline. molybdenum disulfide (0-20 wt. %), pyrolyzed bacterial cellulose (0-50 wt. %) on compressed graphite or metal sheet.

3. The anode electrode active material in claim 1 is the activated carbon deposited on a rigid or flexible graphite or metal sheet.

4. The electrolyte in claim 1 is the glass transitioned gel electrolyte composed of 0.5-1 molarity hydrochloric acid and 1-20 wt. % polyvinyl alcohol.

5. In cathode electrode material in claim 1 is the pyrolyzed bacterial cellulose first dried of free water at 100 to 120° C. and pyrolyzed under an inert nitrogen or argon atmosphere by following the heating protocol: 100-120° C. to 225-275° C. at a slow heating rate (2° C./min), a 225-275° C. hold until complete structural transformation, 225-275° C. to 400-600° C. at a slow heating rate (2° C./min), a 400-600° C. hold until complete structural transformation, and a cooling step to any temperature below 225° C. (non-oxidizing conditions) before introducing to the ambient environment.

6. The pyrolyzed cellulose of claim 5 is used as a scaffold during the “in-situ” polymerization of aniline, the main cathodic precursor material, for enhancing the structural stability of polyaniline during swelling after supercapacitor charging and discharging via hydrogen bonding and carbon-carbon pi-orbital overlapping van der walls forces.

7. In claim 1 the substrate graphite is used as a current collector where active material is deposited with biodegradable binder, carboxymethyl cellulose, to be between 5-20 wt. %, polyvinylidene fluoride (PVDF) or polyvinylpyrrolidone (PVP), is used from 5-20 wt. %.

8. The anode electrode and cathode electrode in claim 1 are fabricated using doctor blade, sprayer and ultrasonicating sprayer for producing high quality films with a controlled thickness.

9. The anode and cathode electrode in claim 1 are fabricated are rolled through a press, whether heated or unheated, for increasing the active material film density and subsequent electrical conductivity, leading to a low resistance and high-performance electrode.

10. In an embodiment of the supercapacitor invention described in claim 1 where graphite is used as a current collector and active material substrate, a copper or aluminum film is deposited using an electrodeposition step (<5V, typically <1V) on a small portion of the graphite current collector for allowing the soldering or welding of a metallic electrical lead (wire, tab, foil, bus bar) onto the electrode assembly for providing a terminal location for circuit hookup and application.

11. In an embodiment of the supercapacitor invention described in claim 1 where graphite is used as a current collector and active material substrate, a metal crimp is used for applying pressure and securing an electrical lead (wire, tab, foil, bus bar) onto the electrode tab assembly for providing a terminal location for circuit hookup and application.

12. In an embodiment of the supercapacitor invention described in claim 1 where a metal foil is used as a current collector and active material substrate, a metal crimp may be used for applying pressure and securing an electrical lead (wire, tab, foil, bus bar) onto the electrode tab assembly or the metallic electrical lead may be welded to the metal electrode tab for providing a terminal location for circuit hookup and application.

13. In an embodiment of the electrodes described in claim 1, they may or may not have undergone a voltage burn in step prior to the supercapacitor assembly, where the supercapacitor electrodes are placed in a beaker of the electrolyte of interest such as the 0.5-1M hydrochloric acid, 5-20 wt. % polyvinyl alcohol gel membrane, or an electrolyte that is similar such as 0.5-1M hydrochloric acid alone, and charged and discharged for 500-15,000 cycles with a potential of 0.5-0.7V between the working electrode and a silver-silver-chloride reference electrode at a high current density of 0.5-10 A/g of cathodic active material.

14. The voltage burns in of claim 10 results in supercapacitor electrodes derived of polyaniline having a greater charging and discharging cycle life and more structural stability than without a burn in step.

15. In another embodiment of the electrodes described in claim 1, they may or may not have undergone a voltage burn in step prior to the supercapacitor assembly, where the supercapacitor cathode and a significantly larger surface area counter electrode, such as an activated carbon coated electrode, are placed in a beaker of the electrolyte of interest such as the 0.5-1M hydrochloric acid, 5-20 wt. % polyvinyl alcohol gel membrane, or an electrolyte that is similar such as 0.5-1M hydrochloric acid alone, and charged and discharged for 500-15,000 cycles with a potential of 0.5-0.7V between the working electrode and a silver-silver-chloride reference electrode at a high current density of 0.5-10 A/g of cathodic active material.

16. The electrolyte in claim 1 utilizes the aqueous gel prepared by dissolving polyvinyl alcohol in the 0.5-1M hydrochloric acid solution and undergoing glass transition in a sealed beaker at 80-100° C. for a residence time proportional to the quantity of electrolyte being prepared and the time required to dissolve the solid PVA and form a glass transitioned material; after which the gel is brought to room temperature and maintains an appropriate viscosity for pouring onto an electrode and initiate gelling via a freeze-dry technique for a time adequate for freezing the gel completely and then being thawed at room temperature.

17. The glass transitioned gel electrolyte mentioned in claim 1 is poured over the coated cathode or anode, or both of them, and the electrodes are then stacked with a level orientation, the assembly is frozen from at any temperature ≤5° C. until completely frozen, and the frozen assembly is thawed at room temperature where the structurally stable gel is formed.

18. The pouch cell described in claim I is fabricated by sandwiching gel electrolyte between anode and cathode electrodes and assembly is encased in a laminated and heat sealable aluminum foil with or without a vacuum drawn inside the pouch prior to sealing or dipped in a polymeric resin coating material such as acrylic, polyurethane, silicone, UV cured epoxy, or 2-part epoxy with the soldered electrical leads protruding from the packaging.
